(19) United States
(12) Patent Application Publication
(10) Pub. No.: US 2011/0255736 A1
(43) Pub. Date: Oct. 20, 2011

(54) NETWORKED IMAGE RECOGNITION METHODS AND SYSTEMS

(75) Inventors: James Thompson, Boston, MA (US); Neal Checka, Cambridge, MA (US); Zachary Cox, Ankeny, IA (US)

(73) Assignee: Pongr, Inc., Boston, MA (US)

(21) Appl. No.: 13/087,762

(22) Filed: Apr. 15, 2011

Related U.S. Application Data
(60) Provisional application No. 61/324,484, filed on Apr. 15, 2010.

(51) Int. Cl. G06K 9/00

(52) U.S. Cl. 382/100

(57) ABSTRACT

An adaptive marketing image recognition system enables internet-based interactivity between individuals, commercial entities, and internet-based social networks. The system may receive a digital image from an individual and process the images to recognize at least one marketing image contained within the digital image. The system may identify at least one commercial entity associated with the marketing image, and provide a marketing response to the individual that may be tailored to the individual. The system may additionally provide marketing responses to members of an internet-based social network to which the individual belongs. Marketing metrics associated with the recognized marketing image and distribution of marketing responses may be compiled by the system and provided to the at least one commercial entity.

### CROSS-REFERENCE TO RELATED U.S. APPLICATIONS

The present application claims the benefit of U.S. provisional patent application No. 61/324,484 of the same title filed on Apr. 15, 2010, which is incorporated herein by reference.

### FIELD OF THE INVENTION

Embodiments of the invention relate to systems, methods and apparatus for implementing image recognition in a network of electronic devices and social networks in connection with product marketing.

### BACKGROUND

Today, people take and submit billions of photographs to social networks via mobile phone or mobile communication devices equipped with cameras. Typically, people use mobile email, picture-texting (MMS), and smart phone applications to send pictures to selected acquaintances or friends that may be members of one or more internet-based social networks. This process is predominantly a one-way submission whereby a user of a mobile device may take a photograph, and send the picture to one or more social networks to which the user belongs. In some cases, a member of the social network may reply with a comment about the picture to the photographer, and may also pass the picture along to other individuals belonging to that member's social network.

If a picture submitted by a user or photographer to a social network comprises a picture associated with a commercial product, advertisement, or commercial marking and the picture becomes popular and widely distributed, the picture and its popularity may go completely unnoticed by a commercial entity, e.g., a vendor or marketer, associated with the commercial product or marking. In all likelihood, the vendor, company, and/or marketer may be unaware that a photograph of their product, commercial marking, or advertisement has been distributed to thousands or millions of people through internet-based social networks.

### SUMMARY

Embodiments of the present invention relate to systems, apparatus and methods for utilizing image recognition in a network of electronic devices in connection with product marketing and social networking. The inventors have recognized that a large number of images that are taken and shared within a social network may be utilized for commercial marketing and/or promotional purposes. For example, a digital photo that contains an image of a commercial product, trademark, corporate logo, and/or slogan may capture popular interest and be shared among hundreds, thousands, or even millions of people over a social electronic network. In this regard, the inventors have recognized and appreciated that image recognition may be used to identify at least one commercial entity associated with a shared image, and return marketing and/or promotional information to an originator of the image. The system may further forward the image and marketing responses to one or more members of a social network to which the originator of the image belongs. Additionally, the image and information, e.g., statistics, relating to the popularity of an image may be provided to the associated commercial entity for use in marketing research and development. Accordingly, systems of the present invention provide means for interactive brand engagement between individuals, social networks, and commercial entities.

In one embodiment, an adaptive marketing image recognition system comprises at least one processor in communication with a network of electronic devices. The at least one processor may be configured to receive a digital image of a scene from a source, e.g. an electronic device that is configured to capture a digital image of a scene and operated by a user. The image recognition system may comprise an image recognizer that is configured to identify at least one portion of the digital image as being associated with at least one commercial entity. For example, the portion of the image may be a commercial marking or product that is marketed or advertised by a commercial entity. The image recognition system may further comprise a response compiler configured to prepare a first and a second marketing response relevant to the recognized portion of the image, and the at least one processor may be configured to return the first marketing response to the source and forward the second marketing response to at least one member, other than the source, of an internet-based social network to which the source belongs.

In one embodiment, a method for adaptive marketing image recognition in a network comprising a plurality of electronic devices comprises an act of receiving, by at least one processor, a digital photograph from a source. The digital photograph may be received as data and may contain at least one marketing image. The method may also comprise processing the digital photograph with an image recognition algorithm, and recognizing, by an image recognizer, a marketing image contained within the digital photograph. The method may further include an act of forwarding, by the at least one processor, a first marketing response to at least one member other than the source of an internet-based social network to which the source belongs.

The foregoing and other aspects, embodiments, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the invention may be shown exaggerated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1 is a block-diagram representation of a network environment in which the adaptive marketing image recognition system may operate.

FIG. 2 depicts an adaptive marketing image recognition system according to one embodiment.

FIG. 3 depicts an embodiment of a computing apparatus on which at least a portion of the adaptive marketing image recognition system may be implemented.

FIG. 4 represents a flow diagram of a method for adaptive marketing image recognition according to one embodiment.

The features and advantages of the present invention will become more apparent from the detailed description set forth below when taken in conjunction with the drawings.

### DETAILED DESCRIPTION

### I. Introduction

With today's mobile communication devices that include image-capture apparatus, there is an increasing velocity of image capture and distribution among internet-based social networks, e.g., networks such as Facebook, Twitter, Flickr, Google Buzz, Myspace, Blogster, etc. Current technology facilitates near instantaneous distribution of an image, and optionally related content such as audio and/or text, to hundreds, thousands, or even millions of individuals. The inventors have recognized and appreciated that the high velocity of image capture and distribution can be utilized for marketing purposes to the mutual advantage of both an individual photographer, members of the photographer's social network, and commercial entity or entities associated with a product or commercial marking that may appear in a photograph taken by the photographer. Embodiments of an adaptive marketing image recognition system described herein provide means by which individuals may interactively engage with a product or brand and at least one commercial entity associated with the product or brand.

In overview of various embodiments of the invention, a digital photograph that is produced by a user of a mobile communication device may be provided as a data structure to an adaptive marketing image recognition system that may be in communication with the mobile communication device over a network. The photo may be provided with geographical information as to where the photograph was taken. The adaptive marketing image recognition system may be configured to analyze the received digital image and detect or recognize certain content in the digital image that is associated with at least one commercial entity. The image recognition system may identify a relevant marketing response (e.g., promotional information, coupons, vendor information, product information) associated with the recognized content, and return at least one marketing response to the originator of the photograph. A marketing response may be prepared or selected based in part on the geographical location at which the photograph was taken. In some implementations, the image recognition system is also configured to share the photo and optionally a link to a relevant marketing response on the photographer's social network page. In some implementations, the image recognition system may be configured to forward the photo and optionally a link to a relevant marketing response, or a marketing response, to members within at least one of the photographer's social networks. In this way, the photographer and members of the photographer's social network may benefit from receiving product information, vendor locations, and promotional discounts.

The adaptive marketing image recognition system may be configured to track various metrics associated with a digital image and/or a marketing image, e.g., total number of distributions, a distribution rate, number of marketing responses provided in connection with the image and/or marketing image, sales associated with a marketing response provided in connection with the image and/or marketing image. Various statistics relating to a distributed photograph and/or marketing image may be compiled by the image recognition system and provided to one or more commercial entities associated with the photograph. For example, a widely distributed photograph containing an image of a specific commercial product, a commercial marking, or advertisement may provide valuable and nearly instantaneous marketing information to a commercial entity or marketing agency associated with the product or advertisement. In this way, commercial entities associated with a product, commercial marking, or advertisement, may benefit from the distribution of digital photographs among internet-based social networks.

The embodiments described herein provide an adaptive marketing image recognition platform that enables image recognition in connection with commercial enterprises and distribution of digital images among internet-based social networks. Commercial entities may target direct marketing responses via email, sms, mms, and/or installable mobile applications responsive to a digital image produced by a network user for distribution, and may obtain information about success of a product, commercial marking, or advertisement based upon the distribution of the image. The embodiments provide for interactive brand engagement between individuals, social networks, and commercial entities. Further aspects and details are described in the following sections.

As an aid for understanding various embodiments of the invention, several terms that are used throughout the application are defined below. The definitions are provided for teaching purposes, and are not intended to narrowly limit the embodiments.

The term “computer-ware” is used herein to refer to software, firmware, hardware, or any combination thereof that may be used for adapting a computing system having one or more processors to operate in a desired manner. When referring to software, computer-ware may be used to refer to computer-readable instructions that, when executed by at least one processor, cause the at least one processor to execute one or more process steps according to the functionality for which the software was designed.

The term “commercial marking” may be used herein to refer to a distinguishing marking that may be associated with a commercial entity. A commercial marking may include a trademark, service mark, brand or brand image, logo, slogan, color combination, sign, symbol, or any other distinguishing marking that may be used to identify a product, service, or commercial entity.

The terms “commercial product” or “product” may be used to refer to a manufactured product or service provided by at least one commercial entity.

The terms “photograph,” “digital photo,” “digital image,” “captured image,” or “photo” may be used herein to refer to an image of a scene that has been captured by an image-capture apparatus and converted into at least one data structure that is suitable for storage and/or display on an electronic video display device. The same teems may also be used to refer to the data structure associated with a corresponding digital image.

The term “marketing image” may be used herein to refer to an image of an advertisement, an image of a product, or an image of a commercial marking. A marketing image may be a portion of, or all of, a digital photo. There may be more than one marketing image in a digital photo.

The term “photographer” may be used herein to refer to a user of an electronic device that is adapted to capture a digital photo and provide the photo for transmission over a network to one or more destinations.

The term “marketing response” may be used herein to refer to any type and form of information associated with a product, commercial marking, or marketing image. A marketing response may include, but not be limited to, any combination of informational items selected from the following set: company information, promotional sales information, product specific information, sales price, coupons, vendor locations, vendor contact information, new or planned product offerings, associated product information, at least one destination identifier, and a copy of a digital image (e.g., the digital image which prompted preparation of the marketing response). In some embodiments, a marketing response may be provided to a photographer and/or member of a photographer's social network as electronic data or as a link (e.g., a URL link) to a device on a network hosting the marketing response.

### II. System and Operating Environment

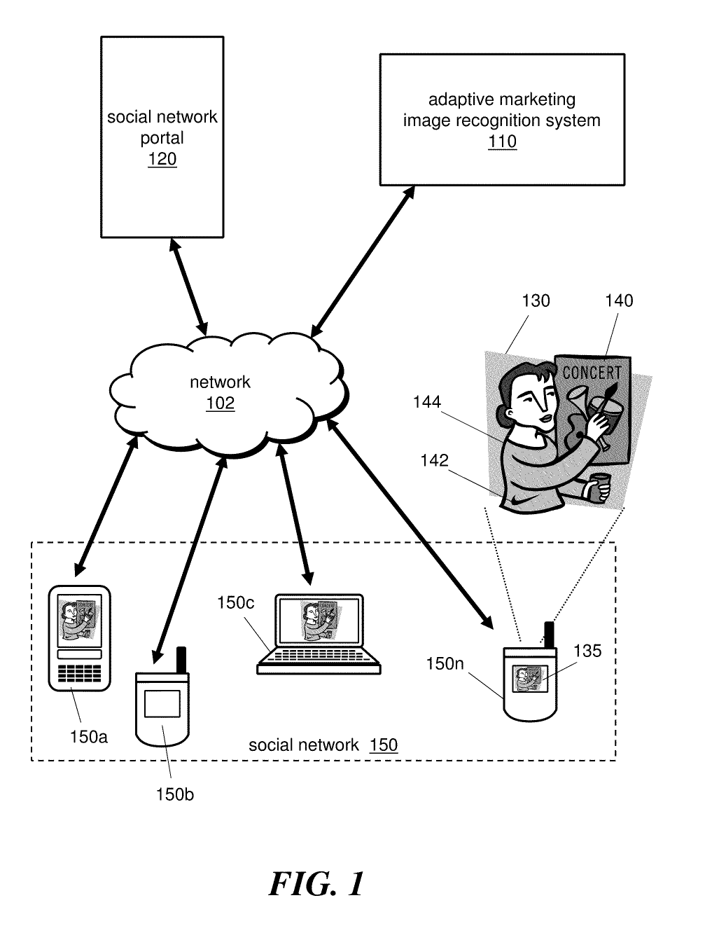

Referring now to FIG. 1, an embodiment of a network environment is shown in which the adaptive marketing image recognition system may operate. In the network environment, there may be multiple electronic devices 150a-n in communication with a network 102. The electronic device may belong to users that subscribe to a common internet-based social network 150, so that information created or received at one device, e.g., mobile phone 150n, may be distributed via network 102 to other devices 150a-150c within the social network. The social network 150 may be defined and managed by a service provider hosting a social network portal 120. Also in communication with the network may be the adaptive marketing image recognition system 110 and at least one social network portal 120 that may support the social network 150.

Network 102 may be a local area network (LAN), a medium area network (MAN), a wide area network (WAN), a virtual network, a wired network, a wireless network, or any combination of the foregoing networks. There may be a plurality of other electronic devices, e.g., internet client and server machines (not shown in FIG. 1), in communication with the network 102. As will be appreciated by those skilled in internet technologies, network 102 may include network links between a wired network, e.g., the world wide web, and a wireless network such as a mobile phone service provider network so that users of mobile communication devices such as mobile phone 150n may communicate with a web-based social network portal 120.

The multiple electronic devices 150a-150n may include without limitation computers, e.g., laptop computer 150c, mobile phones 150b, 150n, tablet or pad devices 150a, as well as any other type and form of electronic device configured for accessing a network. Each of the multiple electronic devices 150a-150n may include image capture apparatus, image display apparatus, and/or image processing computer-ware. In some embodiments, a device (e.g., computer 150c) may be used to alter or create a digital image. In various embodiments, the electronic devices 150a-150n may be adapted to receive and/or transmit a digital image according to one or more communication protocols supported by network 102. Communication with the multiple electronic devices 150a-150n may be wired or wireless.

The electronic devices may be in communication with one or more other electronic devices associated with members of at least one social network through network 102, or may be in direct, e.g., device to device, communication (not shown). In some embodiments, at least one social network 150 may be defined in a portal 120 that provides various web services to clients accessing the portal 120. The multiple electronic devices 150a-150n may be configured as clients of the social network portal 120. Each device 150a-150n may belong to more than one social network maintained by one or more social network service providers.

Portal 120 may comprise computer-ware configured to support services associated with an internet-based social network, such as Facebook or Twitter, for example. The portal 120 may be embodied on one or more internet server machines or comprise one or more server farms. There may be hundreds, thousands, or millions of social networks that are defined and maintained by the social network portal. The social network portal 120 may be configured to provide the adaptive marketing image recognition system 110 access to selected social networks with restricted use priveleges. Although FIG. 1 shows only one social network portal, there may be other social network portals or services in communication with network 102 and adaptive marketing image recognition system 110.

The adaptive marketing image recognition system 110 may comprise computer-ware configured to support services associated with the system 110 and described below. The system 110 may be embodied on one or more internet server machines or comprise one or more server farms. Functionality of the adaptive marketing image recognition system 110 may be distributed in the network 102 on server machines not all operated by a single commercial entity.

In various embodiments, the adaptive marketing image recognition system 110 is in communication with network 102, and may communicate with at least one portal 120 and some or all electronic devices 150a-150n through network 102. In some implementations, the image recognition system 110 may communicate with a social network portal 120 directly (not shown) or via a virtual network having restricted access (not shown).

The system 110 may also be in communication with other entities on the network 102. For example, system 110 may be in communication with portals or servers maintained by one or more commercial entities (not shown). Portals or servers maintained by commercial entities may store and provide content for marketing responses.

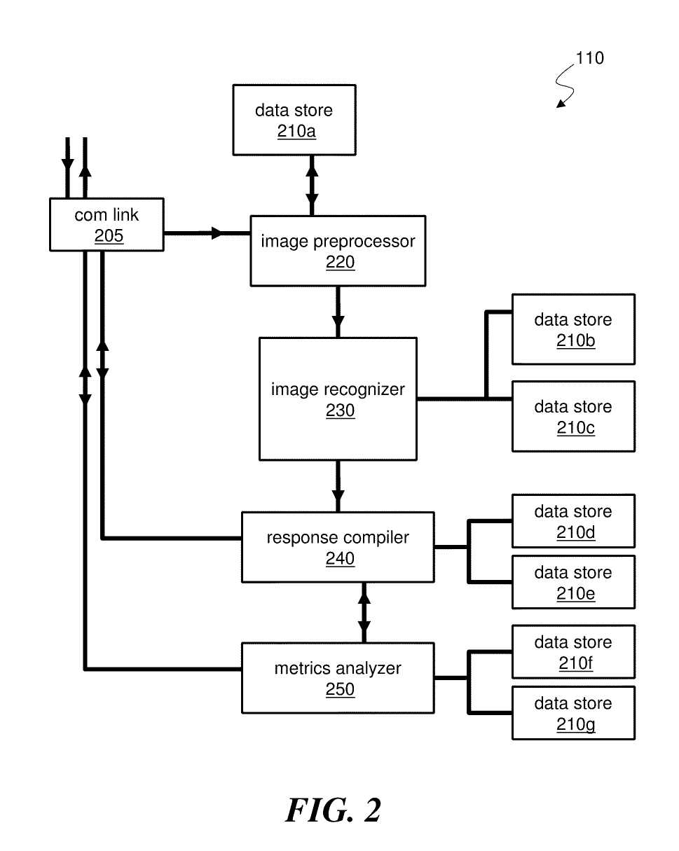

FIG. 2 depicts, in block diagram, one embodiment of an adaptive marketing image recognition system 110. The system 110 may comprise a communication link 205, an image preprocessor 220, an image recognizer 230, a response compiler 240, and a marketing metrics analyzer 250. There may be one or a plurality of data stores 210a-210g in communication with the image preprocessor 220, image recognizer 230, response compiler 240, and marketing metrics analyzer 250. In some embodiments, system 110 may comprise one or more servers configured to provide functionality of image preprocessing, image recognition, response preparation, and marketing metrics analysis as described below. System 110 may be arranged in a server farm managed by a single organization.

As noted above, in some embodiments, components of the system 110 may be distributed in network 102. For example, image preprocessor 220 may be embodied by one or more servers in network 102, and image recognizer 230 may be embodied by one or more servers at a different location in network 102. Similarly, response compiler 240 and metrics analyzer 250 may each be embodied by one or more servers at different locations in network 102. Each of data stores 210a-210g may be embodied as one or more servers at a different location in network 102. When distributed in the network, system 110 may be managed by a single organization, or two or more components of the system may be managed and maintained by separate organizations.

Communication link 205 may comprise computer-ware configured to manage electronic communications between the adaptive marketing image recognition system 110 and network 102. Communication link 205 may comprise a destination address to which digital images may be sent over network 102. Digital images 135 and related content (e.g., audio, text, and/or geographic location at which each digital image was taken) may be received through communication link and forwarded to image preprocessor. Communication link may include the necessary software and hardware to enable communications according to internet protocols and/or protocols established by a service provider, e.g., social network portal 120.

Image preprocessor 220 may comprise computer-ware configured to preprocess received digital images for subsequent image recognition. Preprocessing algorithms may be employed by image preprocessor 220 to expedite image recognition by image recognizer 230. As an example, color may first be removed from the image 135 by preprocessor 220 so as to provide a grayscale image to image recognizer 230. In some implementations, a feature detection algorithm may be employed to extract selected data points from an image for further analysis, e.g., extract edge data points so that an image comprising only edge data points is used for image recognition.

System 110 may be configured to store received images and/or preprocessed images along with related content in one or more data stores 210a. Received images and/or preprocessed images may be stored and queued for subsequent processing if an amount and frequency of received images exceeds processing speeds of system 110.

Image recognizer 230 may comprise computer-ware configured to process and analyze a received preprocessed image, or raw image in some embodiments, and recognize at least one commercial marking or commercial product in the received image. The image recognizer 230 may further be configured to identify respective commercial entities associated with the at least one commercial marking or commercial product recognized in the received image. The image recognizer 230 may process an image 135 in any suitable way to identify a match with at least one commercial entity, e.g., a corporation, vendor and/or marketing agency, associated with at least one marketing image contained within the image 135. The processing can include executing, by the image recognizer 230, one or more machine image recognition algorithms.

As an example of image recognition, one or more features of an image 135 that has been converted to grayscale may be evaluated and compared to feature characteristics of candidate target images that may be stored in data stores 210b-210c that are accessible by image recognizer 230. The target images and/or target image characteristics may be provided by one or more commercial entities and maintained in data stores 210b-210c. The target image characteristics may comprise data representative of feature characteristics of a target image and/or data representative of geometric characteristics of a target image. Any one or combination of various algorithms associated with pattern recognition, e.g., classification algorithms such as neural networks, clustering algorithms such as hierarchical clustering, regression algorithms, and supervised learning methods such as support vector machines, can be used in image recognition of marketing images. In some embodiments, a secondary process may be carried out in which geometric calculations are used to better identify a match between the image 135 and a vendor and/or marketer. Geometric calculations may include, without limitation, ratios of object sizes in an image, aspect ratios of objects, and relative positions of objects. Any type of machine image recognition algorithm may be employed by image recognizer 230 as will be appreciated by those skilled in the art of image recognition.

In some embodiments, image recognizer 230 may further be configured to recognize sentiment and/or at least one biometric of at least one individual in an image. The recognition of sentiment may be based on a facial expression of the at least one individual. Target images and/or target image characteristics associated with different facial expressions (e.g., happiness, sadness, anger, disgust, surprise, joy) may be retained in data stores 210b-210c. A received image 135 may be processed to extract facial expression features for comparison against the target images and/or target image characteristics so that the image recognizer 230 may identify a sentiment of an individual 144 in an image 135. Similarly, the image recognizer 230 may be configured to recognize a biometric of at least one individual in an image. A biometric may include race, age, and/or gender.

Response compiler 240 may comprise computer-ware configured to identify at least one appropriate marketing response for transmission over the network 102 responsive to image recognition results produced by image recognizer 230. The response compiler may be in communication with one or more data stores 210d-210e that retain relevant marketing responses. The response compiler 240 may be configured to select and/or prepare at least one relevant marketing response from the data stores to return to a photographer and/or members of a photographer's social network. In some embodiments, the response compiler may be configured to prepare a first response for the photographer and at least one second response for members of the photographer's social network, wherein the at least one second response differs from the first response. For example, the first response may include a coupon or voucher of higher value than may be provided in the at least one second response. The selection of the marketing response may be based on a commercial entity identified by the image recognizer 230 in connection with a recognized image, related content (audio, text, geographical location at which the image was taken), and/or recognized sentiment of an individual within the image.

The response compiler 240 may be configured to return and/or forward marketing responses responsive to a recognized marketing image to one or more destinations on the network 102. For example, the response compiler may be configured to return a first marketing response to an originator of a digital image (e.g., transmit the first marketing response to the network 102 with at least information identifying a destination address associated with the originator). The response compiler 240 may also be configured to forward at least one second marketing response to at least one other destination, other than the originator of the digital image (e.g., transmit the at least one second marketing response to the network 102 with at least information identifying a destination address associated with an entity other than the originator).

In some embodiments, the response compiler 240 may compile a marketing response comprising at least one identifier for a destination. For example, a prepared marketing response may comprise a first identifier that may identify a destination address to which the marketing response is to be sent. The prepared response may also include a second identifier that identifies a type or form of marketing response that is to be sent. Such a marketing response may then be returned or forwarded to a destination by way of a commercial entity that processes the marketing response. For example, the commercial entity may expand, alter, or otherwise prepare the marketing response based on the second identifier (e.g., the second identifier may indicate a valued customer or “brand ambassador”), and transmit the expanded, altered, or otherwise prepared marketing response according to the first identifier.

Response compiler 240 may further be configured to receive and store information from commercial entities that may be used in preparing and updating marketing responses. For example, response compiler may communicate with internet devices maintained and/or managed by external commercial entities that provide updated information about sales, promotional offers, products, and store locations, or packaged marketing responses to response compiler. In some embodiments, response compiler 240 may receive only URL links and related content from external entities that identify relevant marketing responses.

Marketing metrics analyzer 250 may comprise computer-ware configured to monitor data processing in the adaptive marketing image recognition system 110 and evaluate at least one marketing metric associated with a product or commercial marking that is recognized by image recognizer 230. For example, metrics analyzer 250 may record the number of times a particular product or a particular commercial marking is recognized by the system 110 within a selected time interval, e.g., one hour, one day, one week, one month, or other time interval specified by a user of the system. Such information may be useful to a commercial entity after launching of a new advertising campaign or product, for example. Marketing metrics analyzer 250 may be configured to compile demographic information relating to a product or commercial marking. The demographic information may include age, race, and/or gender statistics of photographers that submit digital images associated with a particular product or commercial marking. Age, race, and/or gender data may be determined from image recognition results produced by image recognizer 230, or may be determined from registration information provided by an originator of a digital image. The demographic information may include geographic statistical information identifying locations (e.g., city, suburbs, national regions, countries) from which digital photos associated with a product or commercial marking are provided. Marketing statistics may be binned according to age, race, gender, and/or geographical location. Marketing metrics analyzer 250 may be configured to record a number and type of distributions of one or more marketing responses provided to individuals over network 102 responsive to recognition of a digital photo. For example, marketing metrics analyzer 250 may record a number of marketing response distributions in association with a photographer who provided an image that was processed by system 110 and resulted in the response distributions.

Marketing metrics analyzer 250 may also be configured to compile associated product statistics and information. For example, several different photographers may submit digital photos containing an image of themselves along with a first product (e.g., an automobile) to system 110 for analysis. The system may process the images and recognize the first product, and also recognize additional products in the photos (e.g., branded beverages, branded apparel, or branded accessories). Marketing metrics analyzer 250 may be configured to compile statistics relating to preference of associated additional products, e.g., a person who likes the first product is most likely to have some interest in a second, third, or fourth product identified in the collection digital photos containing the first product. Although additional products are described above as being in the same photo as the first product, they need not be. For example, photographers submitting photos of the first product may also submit separate photos of additional products. Marketing metrics analyzer 250 may also be configured to compile statistics relating to preference of associated additional products from the separate photographs.

Marketing metrics analyzer 250 may compile statistics and marketing data associated with recognized products and recognized commercial markings. Metrics analyzer 250 may also compile associated product statistics and information. Metrics analyzer may further compile statistics and information for each photographer that uses the system 110. All compiled statistics, marketing data, and related information may be stored in one or more data stores 210f, 210g that are accessible by metrics analyzer 250. Data compiled and stored by metrics analyzer 250 may be provided to commercial entities for marketing research and development.

As shown in FIG. 2, marketing metrics analyzer 250 may communicate with response compiler 240. In some embodiments, metrics analyzer 250 may alter or modify a marketing response compiled by response compiler 240. For example, marketing metrics analyzer 240 may identify at least one associated product that a photographer may be interested responsive to recognition of a product or commercial marking identified in a digital image provided to system 110 by the photographer. As another example, marketing metrics analyzer 250 may identify the photographer as a “brand ambassador” deserving a special or increased discount for a product or associated products, and modify the marketing response accordingly. A brand ambassador may be a photographer who submits a photo to the system 110 that is distributed and/or redistributed to hundreds, thousands, or millions of individuals through one or more internet-based social networks. In some embodiments, marketing metrics analyzer 250 is configured to modify marketing responses compiled by response compiler 240 in accordance with marketing metrics associated with a product, commercial marking, and/or photographer.

Although various components of image recognition system 110 have been described above in one embodiment in connection with FIG. 2, it will be appreciated that an equivalent system may include the functionalities of the components distributed in one or more an alternative arrangements. For example, some functionalities may be combined into one component, or a functionality of one component may be moved to another component. In this regard, functionalities of image preprocessor 220 and image recognizer 230 may be combined in an alternative embodiment into a component that processes received digital images. Similarly, the functionality of identifying at least one commercial entity may be moved from image recognizer 230 to response compiler 240. In some embodiments, functionalities of response compiler 240 and metrics analyzer 250 may be combined into a component that handles image post-processing.

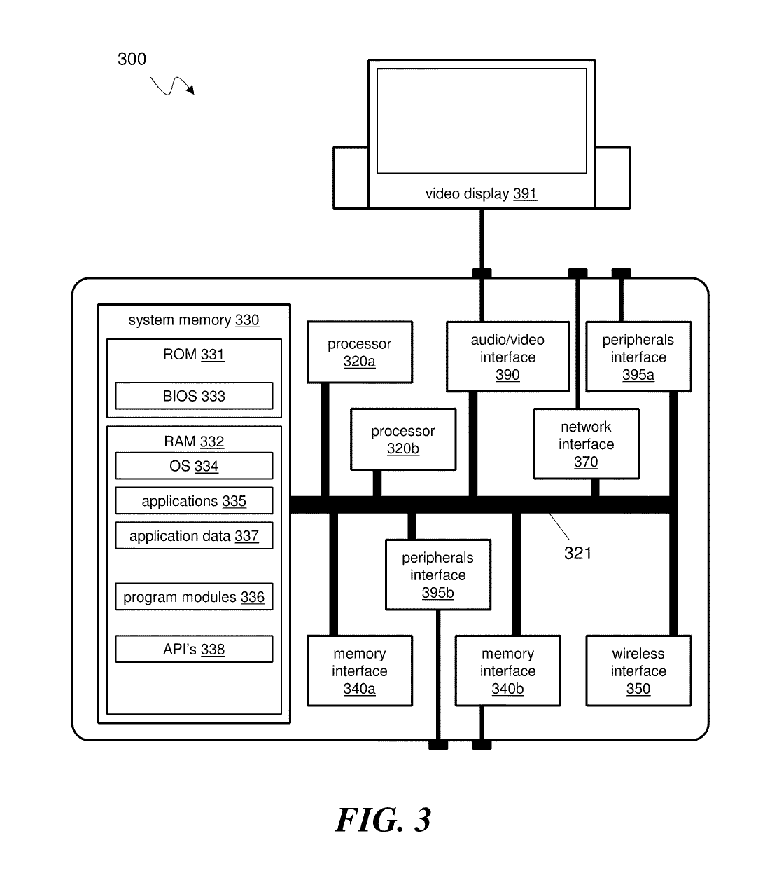

FIG. 3 depicts a computing apparatus that may be used to embody at least a portion of the adaptive marketing image recognition system 110. In some embodiments, any combination of components of the image recognition system 110 shown in FIG. 2 may be embodied as computer-ware on one or a plurality of computing apparatuses depicted in FIG. 3. The computing apparatus 300 may comprise at least one processor 320a, 320b, a system memory 330, and a system bus 321 that couples various system components including the system memory to the at least one processor 320a, 320b. The at least one processor may be a micro-processor. The system bus 321 may be any suitable bus structure, such as a memory bus or memory controller, a peripheral bus, and/or a local bus using any suitable bus architectures. By way of example, and not limitation, such architectures may include Micro Channel Architecture (MCA) bus, Video Electronics Standards Association (VESA) local bus, Peripheral Component Interconnect (PCI) bus, or Serial Advanced Technology Attachment (SATA) bus.

Computing apparatus 300 may include any one or more of a variety of manufactured computer-readable storage media. Computer-readable storage media may be any suitable media that can be accessed by computing apparatus 300, and may include volatile and nonvolatile storage media, and removable and non-removable storage media implemented in any device, method or technology configured for storage of information such as computer readable instructions, data structures, program modules, and/or other electronic data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computing apparatus 300 through system bus 321, including memory interfaces 340a, 340b.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computing apparatus 300, such as during start-up, may be stored in ROM 331. RAM 332 may contain data and/or program modules that are immediately accessible to and/or presently being operated on by a processor 320a, 320b. By way of example, and not limitation, FIG. 3 illustrates an operating system (OS) 334, application programs 335, application programming interfaces (API's) 338, other program modules 336, and program data 337.

The computing apparatus 300 may also include or be configured to accept other manufactured computer storage media that may be removable or non-removable and volatile or nonvolatile, e.g., one or more hard disk drives, one or more magnetic disk drive, one or more optical disk drive, magnetic tape cassettes, flash memory cards, digital versatile disks, digital video tape, solid state RAM, solid state ROM, portable memory sticks, and the like. The additional manufactured computer readable medium may be connected to the system bus 321 through a memory interfaces 340a, 340b.

Computer-readable instructions, data structures, application code, program modules, application programming interfaces (API's), and/or other data for the computing apparatus 300 may be stored on any type of the aforementioned manufactured computer-readable storage media. The computer-readable instructions may comprise encoded instructions that, when executed by at least one processor 320a, cause the at least one processor to execute one or more acts to implementing functionality of the adaptive marketing image recognition system 110.

The computing apparatus 300 may have one or more input and output devices. These devices may be used, among other things, to present a user interface so that a user or system administrator may configure or reconfigure the apparatus 300 for operation. Examples of output devices that may be used to provide a user interface include printers or display screens 391 for visual presentation of output and speakers or other sound generating devices for audible presentation of output. A user may enter commands and information into the computing apparatus 300 through input devices such as a keyboard and/or a pointing device, commonly referred to as a mouse, trackball, touch screen, or touch pad. Other input devices (not shown) may include a digitizing tablet, microphone, joystick, game pad, satellite dish, scanner, or the like. As another example, a computing apparatus 300 may receive input information through speech recognition or in other audible format. These and other input devices may be connected to a processor 320a through one or more peripheral interfaces 395a, 395b that may be coupled to the system bus 321, but may be connected via other interface and bus structures, such as a parallel port, game port or a universal serial bus (USB).

A video display monitor 391 or other type of display device and speakers may also be connected to the system bus 321 via an interface, such as an audio/video interface 390. In addition to the monitor, the computing apparatus 300 may also include other peripheral output devices such as printers and scanners, which may be connected through a peripheral interface 395a.

The computing apparatus 300 may operate in a networked environment using one or more connections to one or more remote devices, such as devices 150a-150n and portal 120 depicted in FIG. 1. The computing apparatus 300 may include a network interface 370 and/or a wireless interface configured to provide access to network 102.

### III. System Operation

An example of operation of the adaptive marketing image recognition system 110 will now be described in connection with a user of the system who may record a digital photograph 135 of a scene 130 and forward the photograph to the system 110 for processing. In some embodiments, the photographer may register with the adaptive marketing image recognition system 110 prior to submitting a digital image. In the process of registering, the photographer may provide registration information to the system 110 so that the system can subsequently uniquely identify the photographer with reference to the registration information. During the process of registration, the photographer may provide the system 110 with information identifying one or more internet-based social networks to which the photographer belongs. The photographer may also provide the system 110 with information that allows the system 110 to interact with one or more of the photographer's social networks on a limited or restricted basis, e.g., post information to a web page authored by the photographer and made publicly viewable through a social network portal 120, forward information to one or more designated friends or acquaintances belonging to one or more social network groups to which the photographer belongs.

In various embodiments, a user operating a mobile electronic device 150n may photograph a scene 130. The scene may be a published advertisement appearing in any medium, e.g., a billboard, a poster, a newspaper ad, a magazine ad, a video display (e.g., a television or computer monitor), and an electronic display (e.g., a billboard). The scene may include a product, a picture of a product, a commercial marking, an advertisement or any combination thereof. The scene may include the user of the mobile electronic device, or another individual. For example, in some instances a user may wish to photograph him or herself in front of an interesting advertisement or product.

A captured image 135 of the scene may then be provided to the adaptive marketing and image recognition system 110. In some implementations, location information is provided along with the image. The location information can comprise latitude, longitude information of the user, as obtained and/or provided by the mobile electronic device 150n. The latitude, longitude information may be obtained from a global positioning system (GPS) and electronic components within the device 150n that determine latitude and longitude from GPS data. A user may also provide to the image recognition system 110 information about a social network to which the user belongs.

In various embodiments, the adaptive marketing and image recognition system 110 may be configured to receive the captured image 135 and process the image to recognize at least one marketing image (for example, trademark 142, advertisement 140) contained within the image 135 and identify a commercial entity associated with the at least one recognized marketing image. The image recognition system 110 may further be configured to identify a location at which the image was taken. In some embodiments, the image recognition system 110 may further be configured to identify an expression of sentiment on one or more individuals 144 within the image 135. The image recognition system 110 may also identify at least one biometric of the one or more individuals 144. After system 110 identifies a match between a recognized marketing image and a commercial entity, the image recognition system can prepare and/or select a relevant marketing response to return to the user who provided the image 135, and may further compile marketing metrics associated with the recognized marketing image.

The adaptive marketing and image recognition system 110 may retrieve from a data store 210d, 210e, responsive to the at least one recognized marketing image, information for at least one relevant marketing response to return to the photographer who provided the image 135. The selection of a marketing response may further be based on recognized sentiment and/or geographic location information provided with the image. The relevant marketing response can include, without being limited in any way, any combination of: a copy of the digital image, product information, price information, availability information, location of nearest vendor, company information, number of members in a common social network who have purchased a product associated with the recognized marketing image, number of members in a common social network who have retrieved information about the product, number of members in a common social network who have photographed the product, coupons, associated products that may be of interest to the photographer, a URL link or electronic address to a web-based purchasing site, a URL link or electronic address to a web-based store of marketing information.

The image recognition system may also post the image 135, along with a link to the relevant marketing response, on the user's social networking page. In some implementations, the image recognition system forwards the image and a link to the relevant marketing response directly to other members of the social network 150a, 150c.

The adaptive marketing image recognition system 110 can further be configured to provide marketing information or marketing metrics associated with a recognized marketing image to one or more commercial entities (e.g., a corporation marketing a product associated with the marketing image, an advertising agency, a broker, an investor) associated with the marketing image, as described above in connection with marketing metrics analyzer 250. As an example, the adaptive marketing image recognition system 110 may provide statistics to at least one commercial entity that identify the number of times a particular image has been submitted for recognition in a time interval. As an additional example, the image recognition system 110 may provide statistics to a commercial entity identifying the number or percentage of members in a social network who have requested product information in response to a particular image forwarded by a social network member. Such information can be used by a commercial entity to evaluate marketing effectiveness of a product, commercial marking, or advertisement.

It will be appreciated from the foregoing descriptions that the adaptive marketing image recognition system 110 can be used to provide feedback or marketing metrics to commercial entities associated with commercial products as well as facilitate free or low cost advertisement for products through internet-based social network distribution. Interactivity can also be through main stream broadcast media, e.g., television, where marketing images may be captured by users while watching television or a computer-based broadcast. The adaptive marketing image recognition system 110 can further provide a highly relevant marketing response to a potential consumer based on identification of an image 135, identification of a location at which the image was taken, and optionally an identification of the consumer/photographer or consumer/photographer demographics. The adaptive marketing image recognition system 110 further provides a system in which a consumer or individual may interactively engage with a brand or product, and possible become recognized by a commercial entity as an ambassador for the brand or product. Additionally, useful marketing metrics can be provided to a commercial entity associated with a marketing image from which the commercial entity can better gauge the effectiveness of an advertisement campaign and/or product, and in some cases obtain near immediate feedback after launch of a product or marketing campaign. The commercial entity may use the marketing metrics to tailor or adapt advertisements and/or products, present or future, to better meet consumer demand.

### IV. Operational Methods

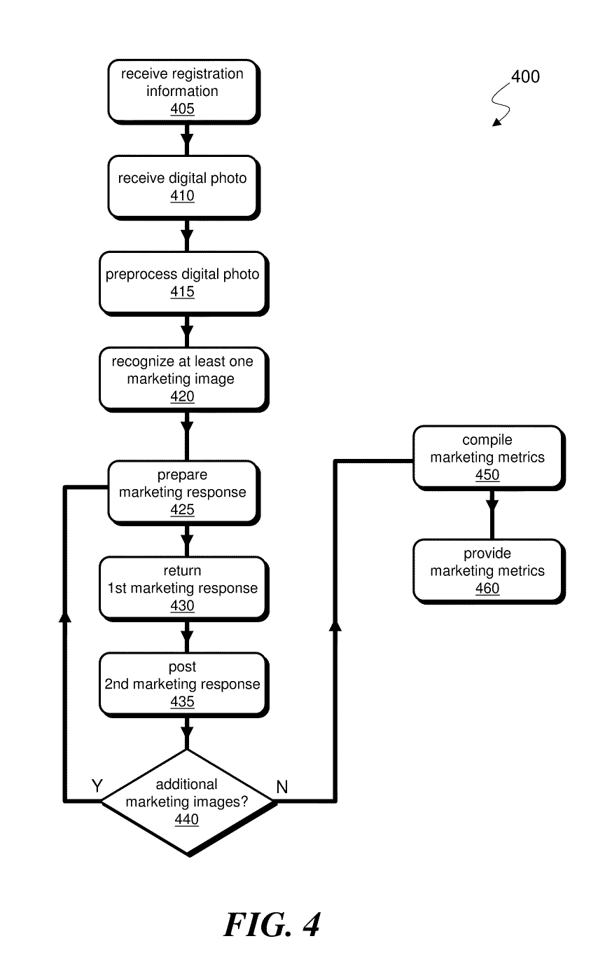

It will be appreciated that there are methods associated with the operation of the adaptive marketing image recognition system 110 described above. FIG. 4 exemplifies one embodiment of a method 400 for adaptive marketing image recognition that may be employed in conjunction with the image recognition system 110. Additional acts described above may be included other embodiments of the method 400, and some acts shown in the method 400 may be omitted in other embodiments of the method.

According to one embodiment shown in FIG. 4, a method for adaptive marketing image recognition may comprise acts of receiving 405 registration information and receiving 410 at least one digital photo from a source. The source may comprise a mobile electronic device that is configured to capture a digital image and forward the image to a destination on a network 102. The mobile device may be operated by a photographer/user. The registration information may comprise any information that may be used by system 110 to uniquely identify photographer. The registration information may also include information identifying one or more internet-based social networks to which the photographer belongs, as well as information that may used by system 110 to gain limited access to the one or more social networks. The act of receiving 410 at least one digital photograph may further include receiving related information, e.g., audio, text, geographical location information, associated with the photograph.

Additional registration information may be received from a commercial entity that wishes to subscribe to services provided by the image recognition system 110. The registration information provided by a commercial entity may include data that can be used by the system 110 to identify one or more marketing images with at least one commercial entity, e.g., the commercial entity providing the registration information, an affiliated commercial entity, a marketing agency. The registration information may further include sample marketing images that may be used by the system 110 as target images for image recognition purposes.

The method 400 may further include acts of preprocessing 415 the received digital photograph and recognizing 420 at least one marketing image in the received photograph. The act of preprocessing may include converting the image to grayscale. The act of image recognition may include recognizing sentiment or at least one biometric of at least one individual in an image. Additional aspects of the acts of preprocessing 415 the image and recognizing 420 at least one marketing response are described above in connection with image preprocessor 220 and image recognizer 240.

The method 400 may further comprise preparing 425 at least one marketing response based, at least in part, on a recognized marketing image. The marketing response may also be based on any combination of: geographic location information received with the image, photographer identity, recognized sentiment, destination to which response will be sent, and marketing metrics associated with the recognized marketing image. In some embodiments, several marketing responses may be prepared, e.g., a first response for transmission to the photographer, a second response for transmission to a first set of members in a first social network to which the photographer belongs, a third response for transmission to a second set of members in a second social network to which the photographer belongs.

Method 400 may further comprise returning 430 a first marketing response to the origination address/photographer of the received digital photograph, and posting 435 a second marketing response to at least one other destination address. The act of posting 435 may comprise posting the received image, optionally with at least one URL link, to a public page of the photographer maintained in an internet-based social network. The act of posting 435 may comprise forwarding a marketing response to at least one member of a social network to which the photographer belongs.

Method 400 may include a step of determining 440 whether additional marketing images were recognized within the received digital photograph. If additional marketing images were recognized, the processing may return to the act of preparing 425 for each additional marketing image that was recognized. If no additional marketing images were recognized, or if no additional marketing images remain to be processed, processing may continue with an act of compiling 450 marketing metrics for each recognized marketing image. Various marketing metrics that may be compiled by system 110 are described above in connection with marketing metric analyzer 250. The act of compiling marketing metrics may include storing the metrics for later retrieval.

The method 400 for adaptive marketing image recognition may further comprise an act of providing 460 marketing metrics to at least one commercial entity associated with each recognized marketing image. The providing 460 of marketing metrics may be executed automatically, for example on a daily or weekly basis, or may be executed responsive to a request by a commercial entity. The providing of marketing metrics may not be made available by the system 110 in some embodiments until meaningful statistics have been compiled for a marketing image.

It will be appreciated that the image recognition system 110 may also be configured for use by non-registered user/photographers. A non-registered user may be identified by an internet address associated with the non-registered user. A digital image received by a non-registered user may be preprocessed 415 and subjected to image recognition 420. Additionally, one or more marketing responses may or may not be prepared 425 and returned 430 to the non-registered user according to the user's internet address, and marketing metrics may be compiled 450. However, when a user is not registered, the aspect of sharing an image and providing marketing responses within a social network to which the user belongs may be disabled or unavailable for use by the non-registered user.

### V. Conclusion

The section headings used herein are for organizational purposes only and are not to be construed as limiting the subject matter described in any way.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments of the invention can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single computer or distributed among multiple computers.

In this respect, various aspects of the invention, e.g., image preprocessor 220, image recognizer 230, response compiler 240, marketing metrics analyzer 250, may be embodied at least in part as a computer-readable storage medium or machine-readable instructions embodied in manufactured computer-readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium or non-transitory medium). The computer-readable storage medium may be encoded with one or more programs that, when executed on one or more computers or other processors, perform methods that implement the various embodiments of the adaptive marketing image recognition system 110. The computer readable medium or media can be transportable, such that the program or programs stored thereon can be loaded onto one or more different computers or other processors to implement various aspects of the present technology as discussed above.

The terms “program” or “software” are used herein in a generic sense to refer to any type of computer code or set of computer-executable instructions that can be employed to program a computer or other processor to implement various aspects of the present technology as discussed above. Additionally, it should be appreciated that according to one aspect of this embodiment, one or more computer programs that when executed perform methods of the present technology need not reside on a single computer or processor, but may be distributed in a modular fashion amongst a number of different computers or processors to implement various aspects of the present technology.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A method for adaptive marketing image recognition in a network comprising a plurality of electronic devices, the method comprising:
receiving, by at least one processor, from a source a digital photograph containing at least one marketing image;
processing the digital photograph with an image recognition algorithm;
recognizing, by an image recognizer, a marketing image contained within the digital photograph; and
forwarding, by the at least one processor, a first marketing response to at least one member other than the source of an internet-based social network to which the source belongs.

2. The method of claim 1, wherein the source comprises a mobile electronic device configured to capture a digital image of a scene and transmit the digital image to a destination on a network, the electronic device further configured to be operated by a user.

3. The method of claim 1, wherein the marketing image comprises a digital image of a product, commercial marking, or advertisement.

4. The method of claim 1, wherein the processing comprises converting the digital image to a grayscale digital image.

5. The method of claim 1, wherein the recognizing further comprises recognizing an expression of sentiment of an individual and/or a biometric of the individual imaged in the digital photograph.

6. The method of claim 1, further comprising identifying at least one commercial entity associated with the recognized marketing image.

7. The method of claim 6, further comprising compiling, by the at least one processor, marketing metrics associated with the recognized marketing image.

8. The method of claim 7, further comprising providing the marketing metrics to the at least one commercial entity.

9. The method of claim 1, further comprising returning, by the at least one processor, a second marketing response to the source.

10. The method of claim 9, wherein the returning comprises posting information on a social network web page associated with the source.

11. An adaptive marketing image recognition system comprising:
at least one processor in communication with a network comprising a plurality of electronic devices, the at least one processor configured to receive a digital image of a scene from a source;
an image recognizer configured to identify at least one portion of the digital image as being associated with at least one commercial entity; and
a response compiler configured to prepare a first and a second marketing response responsive to the identified at least one portion of the image,
wherein the at least one processor is further configured to return the first marketing response to the source and forward the second marketing response to at least one member other than the source of an internet-based social network to which the source belongs.

12. The system of claim 11, wherein the at least one processor is further configured to receive geographical location information with the image, the location information comprising data identifying a location at which the image was captured.

13. The system of claim 12, wherein the response compiler is further configured to prepare the first and/or second response based upon the geographical location information.

14. The system of claim 12, wherein the response compiler is further configured to prepare the first marketing response based on a number of distributions of the digital image and/or second marketing response.

15. The system of claim 11, wherein the image recognizer is further configured to recognize an expression of sentiment on an individual and/or a biometric of the individual that is imaged in the received digital image.

16. The system of claim 15, wherein the response compiler is further configured to prepare the first and/or second response based upon the recognized expression of sentiment.

17. The system of claim 11, further comprising a marketing metrics analyzer configured to compile statistical data associated with the identified at least one portion of the digital image, the statistical data being relevant to marketing.

18. The system of claim 17, wherein the statistical data includes a number of redistributions of the digital image and/or second marketing response binned by age and/or by geographical region.

19. The system of claim 17, wherein the at least one processor is further configured to provide the statistical data to the at least one commercial entity.

20. The system of claim 11, wherein the return of the first marketing response comprises posting information on a social network web page associated with the source.
